(19) United States
(12) Patent Application Publication
(10) Pub. No.: US 2016/0371676 A1
(43) Pub. Date: Dec. 22, 2016

(54) CHECKING THE VALIDITY OF A TRANSACTION VIA THE LOCATION OF A TERMINAL

(71) Applicant: ORANGE, Paris (FR)

(72) Inventors: Olivier Massiere, Paris (FR); Matthieu Verdier, Vincennes (FR)

(21) Appl. No.: 14/901,594

(22) PCT Filed: Jun. 24, 2014
(86) PCT No.: PCT/FR2014/051565

§ 371 Date: Dec. 28, 2015

(30) Foreign Application Priority Data
Jun. 27, 2013 (FR) 1356178

(51) Int. Cl. G06Q 20/32; G06Q 20/40

(52) U.S. Cl. CPC G06Q 20/3224; G06Q 20/405

(57) ABSTRACT

A method for checking the validity of a transaction has the following steps, implemented at a server entity: receiving a transaction request made in a current place for a user of a mobile terminal, the request being an item of data depending on an identifier of the terminal, on the basis of the identifier of the terminal; consulting a database storing previous location data of the terminal; checking the consistency between the current place and said previous locations of the terminal; and determining an action in response to the transaction request, on the basis of the consistency check.

The present invention concerns checking the validity of a transaction.

By way of example, this may be a bank transaction at the time of a payment by bank card, with a payment terminal requesting authorization of the transaction on a server entity that checks the validity of this transaction.

It may be advantageous, within a context where the bearer of the bank card is also the user of a mobile terminal, to check whether the mobile terminal is indeed located at the same place as the transaction by bank card that is in progress. Indeed, document WO2004070492 discloses an implementation in which an increased trust index is accorded to a transaction if the initiator of the transaction is actually located, by virtue of his mobile terminal, in the place of the transaction in progress.

However, within a context in which the bearer of the card would not be the genuine authorized user thereof, it is frequently so that the card has been stolen from this authorized user, just as the mobile terminal of the authorized user has been stolen in the same way, by the same person.

Thus, even though the location of the mobile terminal is tracked down at the same time as the transaction by bank card in document WO2004070492, this document provides no means of protecting oneself against the possibility of theft of both the bank card and the mobile terminal.

Moreover, the genuine holder of the bank card may not have his mobile terminal at the moment of the transaction, which gives rise to a false alarm leading to a negative check on the validity of the transaction.

The present invention will improve the situation.

To this end, it proposes a method for checking the validity of a transaction, having the steps, which are implemented on a server entity, of:
receiving a transaction request made at a current place for a user of a mobile terminal, the request comprising data which are dependent on an identifier of the terminal,
according to the identifier of the terminal, consulting a database storing data of previous locations of the terminal,
obtaining data of the current place and checking a consistency between the current place and said previous locations of the terminal, and
determining an action in response to the transaction request, according to the consistency check.

In this case, “server entity” is understood to mean one or more server devices that are operationally connected to one another, typically via a network, but that are likely to be arranged in different places.

Thus, the present invention anticipates being based on a history of the previous locations of the mobile terminal, in order to check a consistency with the place of the transaction in progress. Consequently, the transaction is not necessarily rejected if the genuine user (for example of a bank card) does not have his mobile terminal with him. Moreover, if both the bank card and the mobile terminal have been stolen by one and the same person, taking account of a history of previous locations makes it possible to check a compatibility between the current place of the transaction (possibly by a malicious user) and previous locations (for example usual locations of the genuine user of the card). If there is no match, typically, it can be ascertained that the bearer of the bank card for the transaction in progress is not situated at a location that is already listed for the mobile terminal, which can lead to the transaction request being rejected.

In one embodiment, the transaction request can be sent from a second terminal (for example a payment terminal reading a bank card, or else a personal computer of the bearer of the card sending a payment order, or the like). Advantageously, in this embodiment, the transaction request comprises data of the current place, corresponding to a geographical position of the second terminal. This arrangement can be implemented on the second terminal (for example the aforementioned payment terminal), in an advantageous manner, in order to insert the current place of the transaction in progress into the transaction request.

In a variant of this embodiment, in order to determine the current place in view of said consistency check, the server entity obtains a current geolocation data of the mobile terminal. To this end, provision may be made for an event to be generated via the cellular network (call, or SMS message notification) in order to create current location data. By way of example, the server can ask the operator of the cellular network that the mobile terminal uses to generate an event (incoming telephone call on the mobile terminal, or SMS notification) creating a location data, which allows the server entity to obtain data of the current place.

Thus, in this variant, the server entity can send a notification to the terminal in order to receive, in response, the current geolocation data.

In this variant, in order to ensure, moreover, that the user of the mobile terminal actually corresponds to the bearer of the bank card, for example, it may be advantageous to provide for the aforementioned notification to invite the user of the terminal to input a personal identification code, this code, once received from the terminal, being checked on the server entity.

In a particular implementation, the database can store a plurality of sets of data of previous locations of a respective plurality of terminals, and, the server entity being connected to said database, the server entity transmits the identifier of the mobile terminal to the base and, in return, obtains the set of data of previous locations of this mobile terminal. Such an implementation is advantageous for providing a transaction validity checking service for a plurality of users of mobile terminals.

However, in a variant of this particular implementation, the terminal can store the aforementioned database in memory, and, on the basis of the identifier of the terminal, the server entity contacts the terminal for the consistency check between the current place and the previous locations of the terminal. In one exemplary embodiment, the terminal can itself compare the current location that the server entity transmits to it with a history of previous locations that is already stored in the terminal, and transmit the result of this comparison to the server entity for the purpose of deciding whether or not this current location has a verified consistency.

In one possible embodiment, the consistency is verified if the current place corresponds to at least one of said previous locations of the mobile terminal.

In a variant of this possible embodiment, data of previous locations have one or more averages for previous locations.

In particular, each average can be estimated over a group of locations that are geographically spaced by a distance below a predetermined threshold.

Thus, the consistency can be verified if the current place is situated around one of said averages, within a radius corresponding to the predetermined threshold, for example.

In one advantageous embodiment, the previous location data can be obtained from location information provided on the initiative of the user, for example for a social network server (for example checkins on Facebook® or on other social networks). Such an implementation makes it possible to ensure confidentiality for the locations of the terminal of the user, these locations not being obtained without his knowledge.

In another exemplary embodiment, data relative to previous locations that are stored in the base can be stored in memory on the initiative of the user, using a notification sent by the server entity, for example by means of a message of SMS type on the mobile terminal, following a validated transaction and asking the user whether he accepts this location being stored in memory for later transactions. These locations stored in memory on the initiative of the user are stored as being usual (without particular risk), which allows subsequent determination of the level of risk associated with a future transaction.

Moreover, the action in response to the transaction request may, by way of example, comprise one element among at least a rejection of the transaction, a favorable follow-up for the transaction (on the understanding that other, later checks are possible, such as a check on the bank card itself or on the bank account of the user), or else the sending of a notification inviting the user to provide a piece of personal information (for example in order to input a personal code on his mobile terminal or in order to input a code received on his mobile terminal in an SMS message on the payment terminal (a method called “3DSecure”), or in order to input a biometric fingerprint, or in order to present an identity document, or the like).

The checks being implemented by the server entity by means of a computer checking application, the present invention is also aimed at such an application in the form of a computer program having instructions for implementing the above method when this program is executed by a processor, for example a processor that the aforementioned server entity has.

As such, the invention is moreover aimed at the server entity for checking the validity of a transaction, having:
a communication interface for receiving a transaction request made at a current place for a user of a mobile terminal, the request comprising data which are dependent on an identifier of the terminal,
a checking module cooperating with the communication interface in order to:
   consult, according to the identifier of the terminal, a database storing data of previous locations of the terminal, and obtain data of the current place in order to check a consistency between the current place and said previous locations of the terminal, and
   determine an action in response to the transaction request, according to the consistency check.

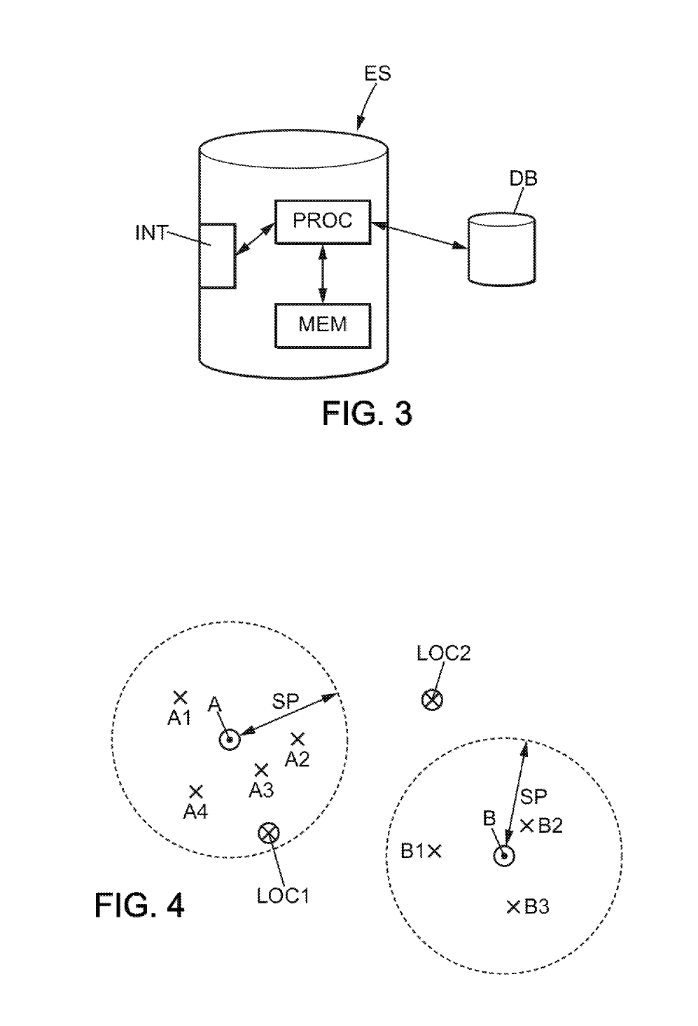

The aforementioned checking module can have software elements (typically the computer program within the meaning of the invention) and hardware elements, such as a processor with which a main memory is associated, for example, as will be seen later on with reference to FIG. 3, which is a schematic and exemplary representation of a server entity within the meaning of the invention.

Moreover, the general algorithm of the computer program within the meaning of the invention can be illustrated by the flowchart in FIG. 2, which is covered below.

Furthermore, other advantages and features of the present invention will emerge upon reading the detailed description below, which is provided by way of nonlimiting example, and on examining the appended drawings, in which:

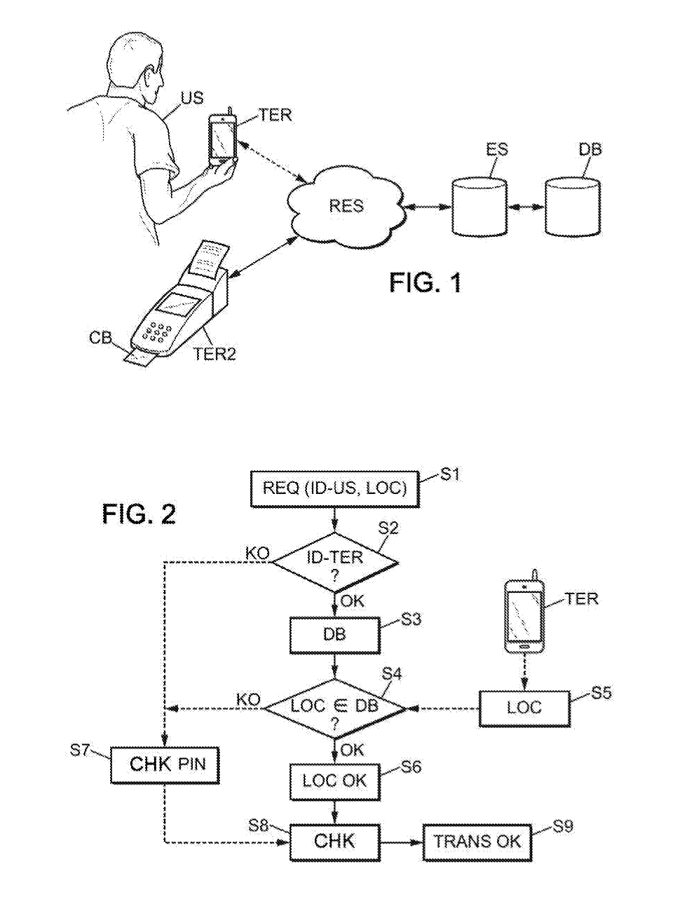

FIG. 1 illustrates a system notably having a server entity ES for implementing the invention,

FIG. 2 illustrates the main steps of the method within the meaning of the present invention, in an exemplary embodiment,

FIG. 3 schematically illustrates elements of a server entity within the meaning of the present invention, in an exemplary embodiment, and

FIG. 4 illustrates processing of positions of locations, in a particular exemplary embodiment.

Reference is first of all made to FIG. 1, which shows a payment terminal TER2 (the aforementioned “second terminal”), which is capable of reading a bank card CB and of thus requesting a transaction, a transaction request message then being sent via a network RES to a server entity ES, in order to check the validity of the transaction.

Within the meaning of the invention, the server entity ES refers to a database DB of previous locations of a mobile terminal TER of the user US who is the authorized holder of the bank card CB. Thus, even if the mobile terminal TER does not accompany the user US, the server entity just refers to a history of previous locations, without any need for the presence of the terminal TER at the moment of the transaction. Moreover, a check is particularly performed for a compatibility between, firstly, a history of the previous locations of the mobile terminal TER (and therefore of its user US) and, secondly, a place of the transaction in progress using the payment terminal TER2. Thus, if an incompatibility is found between the place of the current transaction and the history of the previous locations (for example if the place of the current transaction does not correspond to any of the previous locations), then the server entity ES interprets this as meaning that the current bearer of the bank card CB is positioned at a place that does not correspond to the habits of its genuine holder, which can finish with rejection of the transaction, or else with an additional check requested from the bearer of the bank card. By way of example, if the genuine user of the bank card is usually located by his mobile terminal in the Paris region, while the place of the transaction in progress is tracked down to Marseille (without any occurrence in the history of the previous locations mentioning Marseille as a previous location), this can be interpreted as meaning that the bank card is illegally in Marseille, which can give rise to an additional checking routine on the server entity ES (for example by asking the user to input a particular personal identification code on his mobile terminal, or the like).

FIG. 2 shows the main steps of such a method, which begins in step S1 with a request REQ that is sent by the payment terminal TER2 and that typically has a current location LOC of this terminal

TER2. As a result of the bank card CB being read, the request moreover has an identifier for its genuine user ID-US. This request REQ is sent to the server entity ES, which thus finds, on the basis of the identifier of the user, an identifier ID-TER for its mobile terminal TER, in step S2.

If the user of the bank card is not the holder of a mobile terminal (arrow KO at the output of the test S2), the method can continue with any additional check, such as the input of an additional personal identifier in step S7. On the other hand, if the terminal TER is identified by the server entity ES in step S2 (arrow OK at the output of the test), the server entity ES refers to the database DB, in step S3, in order to obtain the history of the previous locations of the terminal TER.

The database DB of the previous locations can be stored in a memory to which the server entity ES has access, as shown in FIG. 1. In this regard, this memory can be directly integrated on the server entity. The server entity ES, itself, may be in the form of one or more server devices that are connected to one another and that each have, typically, a processor and a main memory, as well as a communication interface, in order to receive requests, to process them and to send a response. Thus, in one possible embodiment, the database DB is stored in a memory that one of these server devices has.

However, in one possible variant, the database of the previous locations DB may be stored in a memory of the terminal itself, as explained later in one embodiment.

In step S4, the server entity determines whether the current location LOC is compatible with the previous locations. The current location LOC may be included in the request REQ, as indicated previously with reference to step S1. Nevertheless, in one possible variant, in which the transaction can be requested from a terminal other than a payment terminal, for example a computer belonging to the holder of the bank card, the current location can be determined by means of simple interrogation of the terminal TER, in step S5.

It should be noted at this juncture that the location of the terminal can be obtained spontaneously using a technique of triangulation over a plurality of base stations. However, the location of the terminal can usually be obtained in a simple manner and can be used directly when the terminal is directly requested by the network RES, for example by the sending of a notification by short messages called SMS, or else by telephone call (in step S5 in FIG. 2). It is possible to take advantage of the notification of an SMS message for the user to give a personal code on his mobile terminal, for example in order to overcome the exemplary case in which the bank card has been stolen at the same time as the mobile terminal of the user.

Nevertheless, the technique aiming at sending notifications to the mobile terminal can be considered intrusive if it involves putting together the history of the previous locations, and it may be preferable to obtain successive location information from the terminal TER, by means of simple choice by its user (information given by the user on a social network, for example, or following acceptance by the user that is given to the server entity regarding storage of a current location data following validation of a transaction). This is how the history of the previous locations can be generated (for example over a chosen period of one year or six months) and then stored in the database DB.

The database DB can be stored in a memory of the server entity ES, as explained previously, or else can be stored on the mobile terminal itself, if there is typically the wish to preserve confidentiality regarding the movements of the user of the mobile terminal. In this case, the comparison between the current location of the transaction and the history of the previous locations can be made on the mobile terminal, itself, while the compatibility check decision, which is made following this comparison, can be taken on the server entity ES, which receives from the mobile terminal a piece of positive or negative information about the aforementioned comparison.

According to any one of the preceding embodiments, in the case of a negative consistency check between the current location and the previous locations in the database DB in step S4 (arrow KO at the output of the test S4), the server entity can decide to effect additional security at step S7 before validating the transaction (for example asking the user to input an additional personal code on the payment terminal TER2, or else asking the user to input a personal code specific to the bank transactions on his mobile terminal TER).

On the other hand, if the current location is consistent with the history of the previous locations (arrow OK at the output of the test S4), the current location is then validated for the transaction in step S6. However, in step S8, other checks that are usually implemented are also implemented in this case (for example the validity of the bank card itself, or else the supply of a corresponding bank account, etc.). By the end of these checks, if they are all positive, of course, the transaction can be followed up favorably in step S9.

FIG. 3 shows an example of the structure of a server entity ES. This typically has a communication interface INT that is capable of cooperating with a processor PROC with which a main memory MEM is associated. In this exemplary embodiment shown in FIG. 3, the server entity can cooperate directly with a mass storage memory accommodating the database of the histories of the previous locations of one or more mobile terminals, this memory being addressable on the basis of a mobile terminal identifier ID-TER in order to retrieve the history of the previous locations of this mobile terminal.

Of course, in this implementation, in which this database DB is stored on the mobile terminal directly, this feature of addressing according to an identifier becomes unnecessary.

Of course, the comparison between the current location LOC and one of the previous locations, if positive, can lead to a positive consistency check between the location of the transaction in progress and the history of the previous locations. However, if the location of the transaction in progress does not correspond to any of the previous locations, this information does not, however, mean that the place of the transaction in progress should be invalidated. This is because, as indicated previously, a user living in the Paris region can move and be situated in an area of the Paris region in which he has never been located previously. In this case, it is preferable to allocate a threshold corresponding to a radius around a previous location, or preferably around an average for a plurality of previous locations, in order to determine whether the location of the transaction in progress is obviously situated in a region known from the history of the previous locations, or whether this current location is obviously foreign to this history. FIG. 4 shows such an implementation in which an average point A is established between a plurality of previous locations A1, A2, A3, A4 that are not more than a predetermined threshold SP apart. In the same way, it is possible to identify a second average represented by the point B in FIG. 4, grouping a plurality of previous locations B1, B2, B3 that are not more than the aforementioned predetermined threshold SP apart. Moreover, if it is difficult to put together groups for which the distance between the positions is no greater than this threshold SP, it is possible to add a temporal criterion for putting together these groups. By way of example, these groups can correspond to positions that have been occupied over one and the same relatively short observation period (for example a fortnight or a month).

Once the groups have been put together and the average points A, B have been obtained, it may be decided, as a consistency check criterion, that if a location of a transaction in progress LOC1 is situated within a radius corresponding to the predetermined threshold SP around one of these averages A, then the location of the transaction in progress can be validated. On the other hand, if a location of a current transaction LOC2 is not situated within a radius SP of either of the averages A or B, then the location of the transaction in progress is not validated (corresponding to the arrow KO at the output of the test S4 in FIG. 2).

Of course, the present invention is not limited to the embodiment described above by way of example; it can be extended to other variants.

Thus, the example of a transaction using a bank card CB has been described above. However, the present invention applies generally to any transaction involving the presence of a user of a mobile terminal at the place of this transaction and at the moment of checking of this transaction. More generally, the term “transaction” covers any type of transaction, notably authentication for controlling access, for example to an Internet site or to any computer application.

Moreover, an exemplary embodiment has been described above in which a simple average is taken for various previous locations of the mobile terminal. Of course, sophisticated models may be provided, for example with an estimation of an average weighted according to the time elapsed since a location time stamp.

1. A method for checking the validity of a transaction, having the steps, which are implemented on a server entity, of:
receiving a transaction request made at a current place for a user of a mobile terminal, the request comprising data which are dependent on an identifier of the terminal,
according to the identifier of the terminal, consulting a database storing data of previous locations of the terminal,
obtaining data of the current place and checking a consistency between the current place and said previous locations of the terminal, and
determining an action in response to the transaction request, according to the consistency check,
wherein said data of previous locations that are stored in the database are stored in memory on the initiative of the user, using a notification transmitted by the server entity following a validated transaction and asking the user to accept memory storage of a current location for later transactions.

2. The method as claimed in claim 1, wherein the transaction request is transmitted from a second terminal and comprises data of said current place, corresponding to a geographical position of the second terminal.

3. The method as claimed in claim 1, wherein, in order to determine the current place in view of said consistency check, the server entity obtains a current geolocation data of the mobile terminal.

4. The method as claimed in claim 3, wherein the server entity sends a notification to the terminal in order to receive, in response, the current geolocation.

5. The method as claimed in claim 4, wherein said notification invites the user of the terminal to input a personal identification code, said code received from the terminal being checked on the server entity.

6. The method as claimed in claim 1, wherein the database stores a plurality of sets of data of previous locations of a respective plurality of terminals, and, the server entity being connected to said database, the server entity transmits the identifier of the mobile terminal to the database and, in return, obtains the set of data of previous locations of this mobile terminal.

7. The method as claimed in claim 1, wherein the terminal stores said database in memory, and, on the basis of the identifier of the terminal, the server entity contacts the terminal for the consistency check between the current place and the previous locations of the terminal.

8. The method as claimed in claim 1, wherein the consistency is verified if the current place corresponds to at least one of said previous locations of the mobile terminal.

9. The method as claimed in claim 8, wherein said data of previous locations comprises one or more averages of previous locations.

10. The method as claimed in claim 9, wherein each average is estimated over a group of locations that are geographically spaced by a distance below a predetermined threshold.

11. The method as claimed in claim 10, wherein the consistency is verified if the current place is situated around one of said averages, within a radius corresponding to said predetermined threshold.

12. The method as claimed in claim 1, wherein the action in response to the transaction request comprises one element among at least a rejection of the transaction, a favorable follow-up for the transaction, the sending of a notification inviting the user to provide a piece of personal information.

13. A computer program having instructions for implementing the method as claimed in claim 1 when this program is executed by a processor.

14. A server entity for checking the validity of a transaction, having:
a communication interface for receiving a transaction request made at a current place for a user of a mobile terminal, the request comprising data which are dependent on an identifier of the terminal,
a checking module cooperating with the communication interface in order to:
consult, according to the identifier of the terminal, a database storing data of previous locations of the terminal, and obtain a data of the current place in order to check a consistency between the current place and said previous locations of the terminal, and
determine an action in response to the transaction request, according to the consistency check,
the data of previous locations that are stored in the database being stored in memory on the initiative of the user, using a notification sent by the server entity following a validated transaction and asking the user to accept memory storage of a current location for later transactions.

15. A mobile terminal for checking the validity of a transaction implemented on a server entity, the transaction corresponding to a transaction request made at a current place for a user of said mobile terminal, the request comprising data which are dependent on an identifier of the terminal, the request being dependent on a consistency between data of the current place and data of previous locations of the terminal that are stored in a database, the terminal comprising:
a communication interface for receiving a notification sent by the server entity following a validated transaction, the notification asking the user to accept memory storage of a current location for later transactions, and for sending, in response to the received notification, a data for accepting memory storage of the current location,
an input interface for receiving, on the initiative of the user, a data for accepting memory storage of the current location.
